(19) United States
(12) Patent Application Publication
(10) Pub. No.: US 2011/0311811 A1
(43) Pub. Date: Dec. 22, 2011

(54) PEKK COMPOSITE FIBRE, METHOD FOR MANUFACTURING SAME AND USES THEREOF

(75) Inventors: Christian Collette, Antony (FR); Philippe Poulin, Talence (FR)

(73) Assignee: Rkema France, Colombes (FR)

(21) Appl. No.: 13/142,089

(22) PCT Filed: Dec. 22, 2009
(86) PCT No.: PCT/FR2009/052665

§ 371 Date: Sep. 9, 2011

(30) Foreign Application Priority Data
Dec. 26, 2008 (FR) 0859090

(51) Int. Cl. D02G 3/00; B29C 51/04; B29C 47/00; B82Y 30/00

(52) U.S. Cl. 428/373; 264/176.1; 264/164; 977/752

(57) ABSTRACT

The present invention relates to a composite fiber containing a thermoplastic polymeric matrix comprising a polyetherketoneketone (PEKK) in which multi-walled nanotubes, especially carbon nanotubes, are dispersed. It also relates to a process for manufacturing this composite fiber and to the uses thereof.

The present invention relates to a composite fiber, especially a conducting one, consisting of a thermoplastic polymeric matrix comprising a polyetherketoneketone (PEKK) in which multi-walled nanotubes, especially carbon nanotubes, are dispersed. It also relates to a process for manufacturing this composite fiber and to the uses thereof.

Conducting fibers capable of allowing an electrical current to flow through them, and of generating heat through the Joule effect, are used for the manufacture of heated fabrics such as clothing, covers, automobile seats or protective linings (intended for example for protecting fuel tanks from the cold).

Conducting fibers are also of use in applications in which the heating effect is not required, for example used for their antistatic properties, in particular in the manufacture of aeronautical or automotive parts or for the electromagnetic shielding of electronic equipment, for example to dissipate electrical charges arising from friction, in particular those induced where fluid is flowing through a thermoplastic pipe.

The conducting fibers known in the prior art comprise:
metal wires, which have the drawback of being heavy and liable to oxidize;
fibers of intrinsically conducting polymers, which are not very washing-resistant and not very stable insofar as they are sensitive to oxidation and also to the heat released by the Joule effect, which may chemically degrade (for example crosslink) the polymer and/or impair its mechanical properties above a certain temperature;
fibers of polymers made conducting by depositing conducting particles on their surface, such as silver-plated fibers, in which the coating is liable to degrade by friction and wear; and
fibers of polymers filled with conducting particles, either based on carbon or metals.

In the latter category of conducting fibers, mention may be made of polymer matrices reinforced by carbon nanotubes, such as those described in the Applicant's patent U.S. Pat. No. 6,331,265. This patent thus discloses various polymer matrices, especially those based on polyetheretherketone (or PEEK), but preferably based on polyolefins, which are reinforced by carbon nanotubes according to a method for optimizing the mechanical properties of the fiber, the electrical conduction properties not being particularly sought.

Now, it occurred to the Applicant that certain composites based on another type of polyetherketone, namely a polyetherketoneketone (or PEKK), and on multi-walled nanotubes, especially carbon nanotubes, would have not only good mechanical properties (especially Young's modulus and fracture strength) but also electrical conduction properties allied with very good thermal stability, enabling them to pass a high current density without the heat released by the Joule effect chemically damaging them, so that their appearance and/or their mechanical properties are substantially impaired. These composites also have good melt spinning capability. This combination of properties makes them well suited for the manufacture of conducting fibers in order to manufacture heated fabrics or other conducting materials, such as those described above, in particular antistatic materials subjected to high thermal and/or mechanical stresses. These composites also exhibit biocompatibility making it possible to envisage using them in biomedical applications, especially for the production of sutures.

Admittedly, it is known from patent application WO 2005/081781 to manufacture composites based on polymers, such as PEEK or PEKK, and on carbon nanotubes. These composites are used to manufacture molded articles intended for the packaging of electronic components or for the production of bipolar plates for electrochemical cells. However, the above application does not envisage making fibers from them.

Likewise, the company Oxford Performance Materials Inc. sold, under the brand names OXXPEKK®, various grades of temperature-stable PEKKs, some of which (OXPEEK®-IG and OXPEEK®-MG grades 230C and 240C) are reinforced by glass fibers or carbon fibers. However, these composites cannot be converted into fibers within the context of the invention. This is because, owing to the diameter of carbon fibers (around 5 to 10 μm), they are difficult to disperse uniformly in the composite fibers and may therefore create defects liable to obstruct the filters or orifices of spinnerets used to form composite fibers.

One subject of the present invention is therefore a composite fiber, especially a conducting one, consisting of a thermoplastic polymeric matrix comprising a polyetherketoneketone (PEKK), in which multi-walled nanotubes, particularly carbon-based nanotubes, are dispersed.

The term “composite fiber” is understood, in the context of the present invention, to mean a fiber consisting of a strand having a diameter between 100 nm and 300 μm, preferably between 1 and 100 μm and better still between 2 and 50 μm.

The term “PEKK” is understood, in the context of this description, to mean a polymer comprising, and preferably consisting of, monomers, satisfying the following general formula (A):

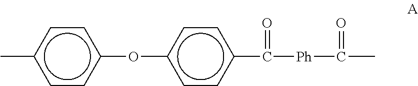

in which Ph represents a 1,4-phenylene group (in which case the —CO—Ph—CO— unit denotes a terephthalyl (T) group) and/or monomers of formula (I) in which Ph represents a 1-3-phenylene group (in which case the —CO—Ph—CO— unit denotes an isophthalyl (I) group). The phenyl groups may optionally be substituted with C₁ to C₈ alkyl groups.

According to one preferred embodiment of the invention, the polymer comprises, and advantageously consists of, a combination of the aforementioned monomers. In this case, the (T)/(I) molar ratio may be between 80/20 and 20/80, preferably between 60/40 and 50/50, limits inclusive.

The PEKK that can be used according to the invention may be crystalline, semicrystalline or amorphous. However, it is preferred to use an amorphous PEKK, making it possible to obtain a more favorable orientation of the polymer chains along the axis of the composite fibers formed from the PEKK, and therefore better mechanical properties of these composite fibers. It is also preferred for the PEKK to have a glass transition temperature (T_{g}) of between 150 and 170° C. (limits inclusive). Its melting point, when it exists, may for example be between 280 and 400° C., preferably between 300 and 370° C., limits inclusive.

PEKKs suitable for use in the present invention are in particular available from the company Oxford Performance Materials under the brand names OXPEKK®-SP, OXPEKK®-C and OXPEKK®-C-E.

Another subject of the present invention is a composite fiber comprising a polymeric matrix containing mainly a polyaryletherketone (PAEK), especially an amorphous one, in which multi-walled nanotubes of at least one chemical element of column IIIa, IVa or Va of the Periodic Table of the Elements are dispersed.

Apart from the PEKK or the PAEK, the polymeric matrix used according to the invention may also contain at least one additive chosen in particular from plasticizers, antioxidants, light stabilizers, pigments or dyes, impact modifiers, antistatic agents, fire retardants, lubricants and mixtures thereof, provided that these additives do not impair the production of a conducting fiber. As a variant or in addition, the polymeric matrix may comprise at least one other thermoplastic polymer compatible with PEKK or made compatible therewith.

The second constituent of the composite fiber according to the invention is a dispersion of multi-walled nanotubes, these advantageously consisting of at least one chemical element chosen from the elements of columns IIIa, IVa and Va of the periodic table. The multi-walled nanotubes may thus be based on boron, carbon, nitrogen, phosphorus, silicon or tungsten. They may for example contain, or for example consist of, carbon, carbon nitride, boron nitride, boron carbide, boron phosphide, phosphorus nitride or carbon boronitride, or else silicon or tungsten.

The advantage of using multi-walled nanotubes lies in the fact that, when they undergo a surface treatment especially to make it easier for processing them or to make them compatible with the matrix, they retain their conducting properties unlike single-walled nanotubes following the alteration of their surface.

According to a preferred embodiment of the invention, multi-walled carbon nanotubes (or CNTs) are used. These are hollow graphitic carbon fibrils each comprising several graphitic tubular walls oriented along the fibril axis. Multi-walled nanotubes having multiple walls may be prepared using a CVD (Chemical Vapor Deposition) process. The multi-walled nanotubes may for example comprise 3 to 15 sheets and more preferably 3 to 10 sheets.

The multi-walled nanotubes to which the invention applies have a mean diameter ranging from 3 to 100 nm, more preferably from 4 to 50 nm and better still from 4 to 30 nm, and advantageously have a length from 0.1 to 10 μm. Their length/diameter ratio is preferably greater than 10 and usually greater than 100 or even greater than 1000. Multi-walled nanotubes thus differ from carbon fibers, which fibers are longer and of larger diameter and therefore lend themselves less well to conventional thermoplastic extrusion techniques than multi-walled nanotubes.

Their specific surface area is for example between 100 and 500 m²/g (limits inclusive), generally between 100 and 300 m²/g in the case of multi-walled nanotubes. Their bulk density may in particular be between 0.05 and 0.5 g/cm³ (limits inclusive) and more preferably between 0.1 and 0.2 g/cm³ (limits inclusive).

One example of raw multi-walled multi-walled carbon nanotubes is in particular commercially available from the company Arkema France under the brand name Graphistrength® C100.

These multi-walled nanotubes may be purified and/or treated (for example oxidized) and/or milled and/or functionalized before they are processed in the process according to the invention.

The milling of multi-walled nanotubes may in particular be carried out cold or hot using known processing techniques in equipment such as ball mills, hammer mills, grinding mills, knife mills, gas-jet impact mills or any other milling system capable of reducing the size of the entangled network of multi-walled nanotubes. It is preferred for this milling step to be carried out using a gas-jet impact milling technique, in particular in an air-jet impact mill.

The raw or milled multi-walled nanotubes may be purified by washing with a sulfuric acid solution so as to strip them of any residual mineral and metallic impurities coming from their production process. The multi-walled nanotube/sulfuric acid weight ratio may especially be between 1/2 and 1/3 (limits inclusive). The purification operation may also be carried out at a temperature ranging from 90 to 120° C., for example for a time of 5 to 10 hours. This operation may advantageously be followed by steps of rinsing the purified multi-walled nanotubes with water and of drying them.

The oxidation of the multi-walled nanotubes is advantageously carried out by bringing them into contact with a sodium hypochlorite solution containing 0.5 to 15% by weight of NaOCl and preferably 1 to 10% by weight of NaOCl, for example in a multi-walled nanotubes/sodium hypochlorite weight ratio ranging from 1/0.1 to 1/1. Advantageously, the oxidation is carried out at a temperature below 60° C. and preferably at room temperature, for a time ranging from a few minutes to 24 hours. This oxidation operation may advantageously be followed by steps of filtering and/or centrifuging, washing and drying the oxidized multi-walled nanotubes.

The functionization of the multi-walled nanotubes may be carried out by grafting reactive entities such as vinyl monomers onto the surface of the multi-walled nanotubes. The constituent material of the multi-walled nanotubes is used as radical polymerization initiator after having been subjected to a heat treatment above 900° C. in an anhydrous and oxygen-free medium, which is intended to eliminate the oxygen-containing groups on its surface.

To eliminate the metallic catalyst residues, it is also possible to subject the multi-walled nanotubes to a heat treatment at a temperature of at least 1000° C., for example 1200° C.

In the present invention, optionally ground raw multi-walled nanotubes are especially used, that is to say multi-walled nanotubes that are neither intentionally oxidized, nor purified, nor functionalized, and that have undergone no other chemical treatment.

Whether or not the multi-walled nanotubes undergo a treatment (chemical or annealing treatment) depends on the final use of the fiber-reinforced thermoplastic.

The multi-walled nanotubes may represent from 0.1 to 50% by weight, and preferably from 1 to 10% by weight, relative to the weight of the composite fiber according to the invention.

The subject of the present invention is also a process for manufacturing the PEKK-based composite fiber described above, comprising the successive steps consisting in:
(a) dispersing the multi-walled nanotubes, optionally in the form of a masterbatch in part of the polymer matrix, into all or the other part of the polymer matrix in order to obtain a composite blend; and
(b) converting said composite blend into fibers.

Step (a), which consists in blending the multi-walled nanotubes into the PEKK, may be carried out in any apparatus. It is preferred that the multi-walled nanotubes and the thermoplastic polymer be blended by compounding using standard devices such as twin-screw extruders or co-kneaders. They may be introduced simultaneously or at different points along the extruder. In this process, polymer granules or powder are typically melt-blended with the multi-walled nanotubes.

As a variant, the multi-walled nanotubes may be dispersed by any appropriate means in the thermoplastic polymer dissolved in a solvent. In this case, the dispersion may be improved, according to one advantageous embodiment of the present invention, by using dispersing systems (such as ultrasound or a rotor/stator system) or else with the aid of particular dispersants.

The dispersants may especially be chosen from plasticizers, in particular cyclized polybutylene terephthalate and mixtures such as the resin CBT® 100 sold by Cyclics Corporation. As a variant, the dispersant may be a copolymer comprising at least one anionic hydrophilic monomer and at least one monomer that includes at least one aromatic ring, such as the copolymers described in document FR-2 766 106, the dispersant/multi-walled nanotube weight ratio preferably ranging from 0.6/1 to 1.9/1. In yet another embodiment, the dispersant may be a vinyl pyrrolidone homopolymer or copolymer, the multi-walled nanotubes/dispersant weight ratio preferably ranging in this case from 0.1 to less than 2. In general, the dispersant may also be selected from synthetic or natural molecules or macromolecules having an amphiphilic character, such as surfactants, with an affinity both for the dispersion medium and for the multi-walled nanotubes.

In a preferred embodiment of the invention, the multi-walled nanotubes used in step (a) are in the form of a masterbatch with part of the polymer matrix and are diluted, in step (a), with the rest of the polymer matrix and the plasticizer, such as the resin CBT® 100 sold by Cyclics Corporation, the concentration of which will depend on the multi-walled nanotube content. In this embodiment, the multi-walled nanotubes may represent from 3% to 30% by weight, preferably 5% to 20% by weight, relative to the weight of the masterbatch. In this preferred embodiment, the choice of the matrix is preferably amorphous PEKK in powder form and the blending is advantageously carried out using a BUSS co-kneader with an L/D ratio between 11 and 15.

In a second preferred embodiment of the invention, the masterbatch consisting of amorphous PEKK, multi-walled nanotubes and plasticizer will be used for formulations based on PERK, PEEK or any other crystalline PAEK optionally containing fibers (carbon or glass fibers) or even other mineral fillers.

The composite blend resulting from step (a) is then converted into fibers in step (b). These fibers may advantageously be formed using a melt spinning process, preferably by passing them through an extruder provided with a small-diameter die. It may be advantageous to carry out this step in an inert atmosphere so as to preserve the structure of the multi-walled nanotubes. According to another embodiment, the fibers may be obtained using a solvent-based process.

The process according to the invention may also include an additional step (c) consisting in drawing the resulting fibers, at a temperature above the glass transition temperature (T_{g}) of the PEKK and preferably below its melting point (if it exists). Such a step, described in the patent U.S. Pat. No. 6,331,265, which is incorporated here by reference, makes it possible to orient the multi-walled nanotubes and the polymer substantially in the same direction, along the fiber axis, and thus improve the mechanical properties of the fiber, especially its tensile modulus (Young's modulus) and it tenacity (fracture strength). The draw ratio, defined as the ratio of the length of the fiber after drawing to its length before drawing, may be between 1 and 20, preferably between 1 and 10, limits inclusive. The drawing may be carried out just once, or several times leaving the fiber to relax slightly between each drawing operation. This drawing step is preferably carried out by passing the fibers over a series of rolls rotating at different speeds, those onto which the fiber is paid out rotating at a lower speed than those from which it is wound up. To achieve the desired drawing temperature, it is possible either to make the fibers pass through ovens placed between the rolls, or to use heated rolls, or to combine these two techniques. The drawing step is facilitated by using amorphous PEKK.

This drawing step makes it possible to consolidate the fiber and achieve high fraction strengths.

Furthermore, although the composite fibers obtained according to this process are intrinsically conducting, that is to say they have a resistivity of possibly less than 10⁵ ohms·cm at room temperature, their electrical conductivity may be further improved by heat treatments.

Finally, these composite fibers are capable of withstanding high current densities without their mechanical properties or their appearance being substantially impaired, because, on the one hand, of the good thermal stability of PEKK and, on the other hand, the capability of multi-walled nanotubes to dissipate heat.

The subject of the present invention is also a process for manufacturing a composite fiber, comprising the following steps:
(a) dispersion of multi-walled nanotubes of at least one chemical element from column IIIa, IVa or Va of the Periodic Table of the Elements in a thermoplastic matrix containing mainly a polyaryletherketone (PAEK);
(b) conversion of the resulting blend in order to form a fiber; and
(c) optional drawing of the resulting fiber.

On account of the advantageous properties described above, the composite fibers according to the invention may be used for the manufacture of: nosecones, wings or fuselages of rockets or aircraft; off-shore flexible pipe reinforcements; automobile body or engine chassis components; antistatic packages and textiles, especially for the protection of silos; electromagnetic shielding devices, especially for the protection of electronic components; heated fabrics; conducting cables; sensors, especially mechanical strain or stress sensors; or biomedical devices, such as sutures or catheters.

Another subject of the invention is in particular a structural composite part containing composite fibers (based on PEKK or PAEK) as described above.

The manufacture of these composite parts may be carried out using various processes, in general involving a step of impregnating the fibers with a polymeric matrix. This impregnation step may itself be carried out using various techniques, depending in particular on the physical form of the matrix used (powder or relatively liquid form). The fibers may preferably be impregnated using a fluidized-bed impregnation process, in which the polymeric matrix is in a powder state. The fibers themselves may be impregnated as such or after a step of weaving them into a fabric consisting of a bidirectional network of fibers.

The fibers according to the invention may be introduced into a thermoplastic, an elastomer or a thermoset.

These semifinished products are then used in the manufacture of the desired composite part. Various prepreg fabrics, of the same or different composition, may be stacked to form a sheet or laminate or, as a variant, subjected to a thermoforming process. In all cases, the manufacture of the finished part includes a step of consolidating the polymeric matrix which is for example locally heated to create areas where the fibers are fastened to one another.

As a variant, it is possible to produce a film from the impregnation matrix, especially by means of an extrusion or calendering process, said film having for example a thickness of about 100 μm, the film then being placed between two fiber mats and the assembly then being hot-pressed in order to impregnate the fibers and to manufacture the composite.

In these processes, the impregnation matrix may comprise a thermoplastic, elastomeric or thermosetting polymer or a blend of these. Said polymer matrix may itself contain one or more fillers or fibers.

Moreover, the composite fibers according to the invention may be woven or knitted, by themselves or with other fibers, or may be used, by themselves or in combination with other fibers, for manufacturing felts or nonwoven materials. Examples of materials making up these other fibers comprise, without being exhausted:
drawn polymer fibers, based especially on the following: a polyamide, such as nylon-6 (PA-6), nylon-11 (PA-11), nylon-12 (PA-12), nylon-6,6 (PA-6,6), nylon-4,6 (PA-4,6), nylon-6,10 (PA-6,10) or nylon-6,12 (PA-6,12); a polyamide/polyether block copolymer (Pebax®), high-density polyethylene; polypropylene; or a polyester such as polyhydroxyalkanoates and polyesters sold by Du Pont under the brand name Hytrel®;
carbon fibers;
glass fibers, especially E-glass, R-glass or S2 glass fibers;
aramid (Kevlar®) fibers;
boron fibers;
silica fibers;
natural fibers, such as flax, hemp, sisal, cotton or wool fibers; and
mixtures thereof, such as mixtures of glass, carbon and aramid fibers.

### EXAMPLE 1

PEKK (96 wt %) of OXPEKK®-SP grade from Oxford Performance Material, and Graphistrength® multi-walled carbon nanotubes from Arkema (3 wt %) and the plasticizer CBT® 100 (1 wt %) were introduced via a feed hopper into a twin-screw extruder (L/D=40) heated to 380° C. The extruded rod obtained from the die was cooled in a water tank and then granulated and dried.

### EXAMPLE 2

The granules obtained in Example 1 were introduced into a single-screw extruder (L/D=16) heated to 390° C. and fitted with a die with 0.5 mm holes. The fibers obtained were drawn on the drawing rig in such a way that the final diameter stabilized at 100 μm, these being cooled in air and then wound up on a reel using a suitable device.

1. A composite fiber, especially a conducting one, consisting of a thermoplastic polymeric matrix comprising a polyetherketoneketone (PEKK) in which multi-walled nanotubes are dispersed.

2. The composite fiber as claimed in claim 1, characterized in that the multi-walled nanotubes contain, especially consist of, carbon, carbon nitride, boron nitride, boron carbide, boron phosphide, phosphorus nitride, carbon boronitride, silicon or tungsten.

3. The composite fiber as claimed in claim 2, characterized in that the multi-walled nanotubes are multi-walled carbon nanotubes.

4. The composite fiber as claimed in any one of claims 1 to 3, characterized in that the multi-walled nanotubes represent from 0.1 to 50% by weight, and preferably from 1 to 10% by weight, relative to the weight of the fiber.

5. The composite fiber as claimed in any one of claims 1 to 4, characterized in that the PEKK is amorphous.

6. The composite fiber as claimed in any one of claims 1 to 5, characterized in that the PEKK has a glass transition temperature (T_{g}) of between 150 and 170° C. (limits inclusive).

7. The use of a composite fiber as claimed in any one of claims 1 to 6, for the manufacture of: nosecones, wings or fuselages of rockets or aircraft; off-shore flexible pipe reinforcements; automobile body or engine chassis components; antistatic packages and textiles; electromagnetic shielding devices, especially for the protection of electronic components; heated fabrics; conducting cables; sensors, especially mechanical strain or stress sensors; or biomedical devices, such as sutures or catheters.

8. A process for manufacturing a composite fiber as claimed in any one of claims 1 to 6, comprising the successive steps consisting in:
(a) dispersing the multi-walled nanotubes, optionally in the form of a masterbatch in part of the polymer matrix, into all or the other part of the polymer matrix in order to obtain a composite blend; and
(b) converting said composite blend into fibers, preferably using a melt spinning process.

9. The process as claimed in claim 8, characterized in that it includes an additional step (c) consisting in drawing the resulting fibers at a temperature above the glass transition temperature of the PEKK and preferably below its melting point.

10. A composite fiber comprising a polymeric matrix containing mainly a polyaryletherketone (PAEK), especially an amorphous one, in which multi-walled nanotubes of at least one chemical element of column IIIa, IVa or Va of the Periodic Table of the Elements are dispersed.

11. A process for manufacturing a composite fiber, comprising the following steps:
(a) dispersion of multi-walled nanotubes of at least one chemical element of column IIIa, IVa or Va of the Periodic Table of the Elements in a thermoplastic matrix containing mainly a polyaryletherketone (PAEK);
(b) conversion of the resulting blend in order to form a fiber; and
(c) optional drawing of the resulting fiber.

12. A structural composite part containing composite fibers as claimed in any one of claims 1 to 10.
